(19) United States
(12) Patent Application Publication
(10) Pub. No.: US 2025/0272535 A1
(43) Pub. Date: Aug. 28, 2025

(54) METHOD AND SYSTEM FOR PREDICTING TEMPERATURE OF A THERMAL SYSTEM

(71) Applicant: Robert Bosch GmbH, Stuttgart (DE)

(72) Inventors: Hung Le Minh, Hochiminh City (VN); Huy Le Dang, Hochiminh City (VN); Kevin Tom, Singapore (SG); Thien Vo Minh, Hochiminh City (VN); Zaki Mohzani, Tamm (DE)

(21) Appl. No.: 18/704,998

(22) PCT Filed: Oct. 28, 2021
(86) PCT No.: PCT/EP2021/079976

§ 371 Date: Apr. 26, 2024

(51) Int. Cl. G06N 3/0442; G06N 3/09

(52) U.S. Cl. CPC G06N 3/0442; G06N 3/09

(57) ABSTRACT

There is provided a method for predicting temperature of a thermal system, using at least one processor. The method comprises receiving multivariate time-series input data associated with the thermal system, wherein the multivariate time-series input data includes time-series temperature and one or more time-series variables. The method further comprises pre-processing the multivariate time-series input data and processing the pre-processed multivariate time-series input data in a machine learning architecture. The method also comprises outputting from the machine learning architecture, temperature predictions for the thermal system based on the processed multivariate timeseries input data.

### TECHNICAL FIELD

The present disclosure generally relates to a method and a system for predicting temperature of a thermal system.

### BACKGROUND

White-box modelling techniques are used to predict temperature of a thermal system. This involves the following steps: collecting temperature data during thermal runs; guessing the actual thermal network in order to model the phenomena; fitting the data to a thermal network; and repeat the preceding steps if the model fit is poor.

There is a need to improve the method for predicting temperature of a thermal system with various thermal capacity.

### SUMMARY

According to a first aspect of the present disclosure, there is provided a method for predicting temperature of a thermal system, using at least one processor, the method comprising: receiving multivariate time-series input data associated with the thermal system, wherein the multivariate time-series input data includes time-series temperature and one or more time-series variables; pre-processing the multivariate time-series input data; processing the pre-processed multivariate time-series input data in a machine learning architecture; and outputting, from the machine learning architecture, temperature predictions for the thermal system based on the processed multivariate time-series input data.

According to a second aspect of the present disclosure, there is provided a system for predicting temperature of a thermal system, the system comprising: a memory; and at least one processor communicatively coupled to the memory and configured to: receive multivariate time-series input data associated with the thermal system by a data receiving module, wherein the multivariate time-series input data includes time-series temperature and one or more time-series variables; pre-process the multivariate time-series input data by a data preparation module; process the pre-processed multivariate time-series input data in a machine learning architecture by a machine learning module; and output by an output module, from the machine learning architecture, temperature predictions for the thermal system based on the multivariate time-series input data.

According to a third aspect of the present disclosure, there is provided a computer program product, embodied in one or more non-transitory computer-readable storage mediums, comprising instructions executable by at least one processor to perform a method for predicting temperature of a thermal system, the method comprising: receiving multivariate time-series input data associated with the thermal system, wherein the multivariate time-series input data includes time-series temperature and one or more time-series variables; pre-processing the multivariate time-series input data; processing the pre-processed multivariate time-series input data in a machine learning architecture; and outputting, from the machine learning architecture, temperature predictions for the thermal system based on the processed multivariate time-series input data.

### BRIEF DESCRIPTION OF THE DRAWINGS

Embodiments of the present disclosure will be better understood and readily apparent to one of ordinary skill in the art from the following written description, by way of example only, and in conjunction with the drawings, in which:

FIG. 1 depicts a flow diagram of a method for predicting temperature of a thermal system, according to various embodiments of the present disclosure;

FIG. 2 depicts a visualization of data preparation for training phase, validation phase and testing phase for (a) prediction of a battery's temperature and (b) prediction of a diesel generator (genset)'s temperature, according to various embodiments of the present disclosure;

FIG. 3 depicts a schematic block diagram of an exemplary Long Short-Term Memory (LSTM) architecture in which the method of FIG. 1 may be realized or implemented, according to various embodiments of the present disclosure; and

FIG. 4 depicts a schematic block diagram of a system for predicting temperature of a thermal system, according to various embodiments of the present disclosure.

### DETAILED DESCRIPTION

Various embodiments of the present disclosure provide a method and a system for predicting temperature for a thermal system.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “generating”, “determining”, “pre-processing”, “processing”, “outputting” or the like, refer to the actions and processes of a computer system, or similar electronic device, that manipulates and transforms data represented as physical quantities within the computer system into other data similarly represented as physical quantities within the computer system or other information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

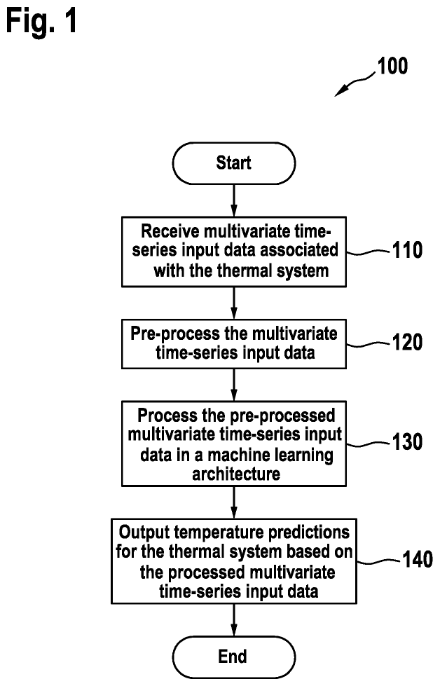

FIG. 1 is a flow diagram depicting a method 100 for predicting temperature of a thermal system, according to various embodiments of the present disclosure. The method may be performed by one or more processors.

Referring to FIG. 1, the method 100 may comprise: receiving (in 110) multivariate time-series input data associated with the thermal system, wherein the multivariate time-series input data includes time-series temperature and one or more time-series variables; pre-processing (in 120) the multivariate time-series input data; processing (in 130) the pre-processed multivariate time-series input data in a machine learning architecture; and outputting (in 140), from the machine learning architecture, temperature predictions for the thermal system based on the processed multivariate time-series input data.

In various embodiments, time-series data refers to a set of data points collected over time intervals; in other words, a sequence of data points associated with timestamps. The time-series input data used herein has the common meaning as a person skilled in the art would understand and, in particular, refers to measurements of the thermal system over a period of time. The time intervals at which the time-series input data is collected may be varied, and comprise, for example, 1 minute, 5 minute or half an hour. The time intervals may be equally spaced or non-equally spaced. A multivariate time-series data consists of more than one time-dependent variable and each variable may depend not only on its past values but also have some dependency on other variables. The relationships between the multivariate time-series data may be analysed and used for the predictions. Determining the relationships between the time-series temperature and the one or more time-series variables may comprise performing a correlation test between the time-series temperature and the one or more time-series variables.

The multivariate time-series input data may be collected using sensors disposed in the thermal system and transmitted to a server for storage and/or analysis.

Pre-processing the multivariate time-series input data may comprise resampling the multivariate time-series input data to obtain resampled input data, the data points of which are spaced at equal time intervals; normalizing a value of the multivariate time-series input data to a range [0, 1]; and transforming time-series format into supervised-learning format. Resampling may involve changing the frequency of the time-series data and may include upsampling where the frequency of the data is increased, such as from minutes to seconds, and/or downsampling where the frequency of the data is decreased, such as from days to months. The multivariate time-series input data may be resampled by changing the frequency thereof such that the data points are spaced at equal time intervals which may be 1 minute apart, 0.5 hours apart, 1 month apart or any appropriate time interval as requested.

Normalization may be used to rescale the multivariate time-series input data from the original range to be within the range of 0 and 1. Alternatively, standardizing May be used to rescale the distribution of the multivariate time-series input so that the minimum value is 0 and the maximum value is 1. Additionally or alternatively, the multivariate time-series input data may go through a stationary test for each variable. If the data points are not stationary, it may be made stationary accordingly. The multivariate time-series input data may be transformed from a sequence, i.e. time-series format into pairs of input and output sequences, i.e. supervised-learning format, for use in a supervised machine learning. Machine training may be supervised or unsupervised. In supervised training, the training data includes input and a “known” output. The machine learning algorithm applies the model parameters (typically including weights and bias) and the input to generate a predicted output. An error or variance between the predicted output and the known output is calculated using an objective function and optimized by adjusting the model parameters. Supervised machine learning is applied in the description; however it can be understood by a person skilled in the art that un-supervised machine learning can also be applied with the teachings from the description herein to fit the algorithm of the model learning model.

It would be appreciated by a person skilled in the art that the order of the pre-processing steps, that are resampling, normalization followed by transforming, is not fixed, and it could be normalization, resampling followed by transforming. The order described herein should be understood as an example without limitation to the scope of the present disclosure.

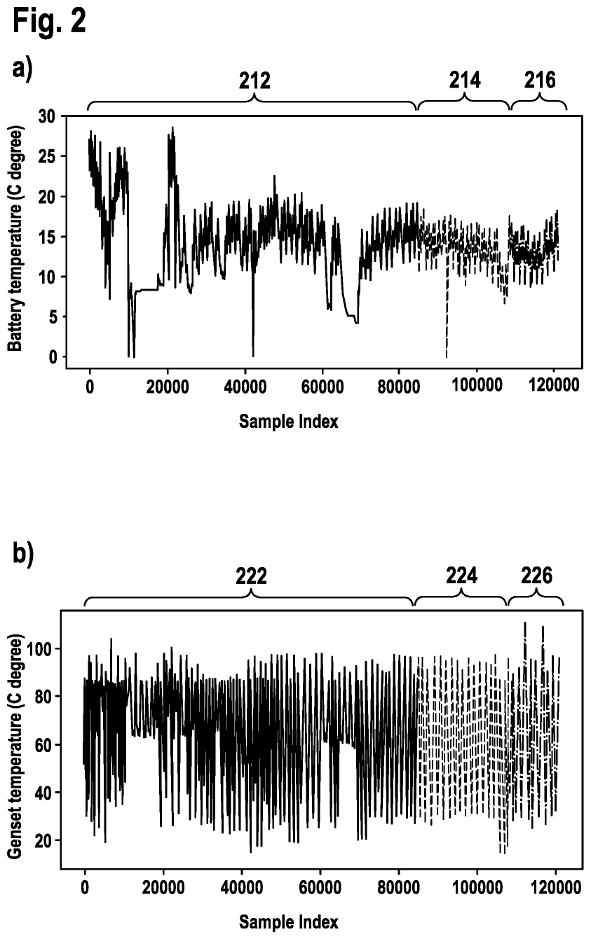

FIG. 2 depicts a visualization of data preparation for training phase, validation phase and testing phase for (a) prediction of a battery's temperature and (b) prediction of a diesel generator (genset)'s temperature, according to various embodiments of the present disclosure. The multivariate time-series input data may be further split into training data 212, 222, validation data 214, 224, and testing data 216, 226. The processing of the pre-processed multivariate time-series input data in the machine learning architecture May further comprise: a training phase, in which the training data is fed to an algorithm of the machine learning architecture; a validation phase, in which the validation data is fed to the algorithm of the machine learning architecture; and a test phase, in which the test data is fed to the algorithm of the machine learning architecture.

The pre-processed time-series multivariate data will be then processed in a machine learning architecture. The machine learning architecture may be a neural network and developed through a multivariate modelling, time-series architecture as a singular time-series variate (i.e. temperature) may not be adequate to predict itself in advance.

Recurrent Neural Network (RNN) and Long Short-Term Memory (LSTM) are variants of neural networks, which contain cycles in the neuron connections, such that the network maintains memory based on previous data points that were passed to the network.

These models explicitly operate on ordered sequences of data points and are suited for time-series analysis. RNN suffers from the vanishing gradient problem and is easily saturated whereas LSTM resolves this problem by preserving the error that is back-propagated through time and through layers, i.e., LSTM maintains a more or less constant error. For practical purposes, an LSTM may be considered as a black box-one whose training will converge faster, is capable of memorizing significant correlations in the data and learning long-term dependencies in the time-series data.

The objective of machine learning or deep learning is to build a model of behavior from past data and use this constructed model to predict or forecast future behavior. The terms “machine learning architecture” and “machine learning model” are used interchangeably in the description herein. Building the machine learning architecture for predicting temperature of a thermal system involves fitting a mathematical algorithm with the multivariate time-series multivariate data.

In various embodiments, the thermal system may include an energy storage system, for example, a battery. The thermal system may also include an energy supply system, for example, a diesel generator. The thermal system may further include an air-conditioning system, a ventilation system and the like. The thermal system may comprise an enclosed system or an open-air system.

In a non-limiting embodiment, where the thermal system comprises a battery, the multivariate time-series input data comprises a time-series variable that represents State-of-Charge (SoC) of the battery. The SoC is the level of charge of an electrical battery relative to its capacity, ranging from 0 to 100%. The battery may be set to charge if the SoC is below a certain percentage, for example, 15% and to discharge if the SoC is above a certain percentage, for example, 85%, by its management system. The battery may also charge or discharge in other scenarios in accordance with its management system. The battery management system may communicate the real time SoC with timestamps to the thermal system. The charging and discharging process may affect the battery's temperature and the temperature of its surroundings. For example, the battery's temperature may be higher when it is in charge or discharge cycle than when it is idle. The algorithm of the machine learning model for predicting the battery's temperature may comprise a function of the SoC.

In a non-limiting embodiment, the thermal system may further comprise a diesel generator, and the multivariate time-series input data may comprise a time-series variable representing a power parameter of the diesel generator. A diesel generator (or genset) is the combination of a diesel engine with an electric generator to generate electrical energy. The system may predict temperature of the diesel generator based on its time-series power parameter of the diesel engine. The electrical energy generated by the diesel generator may be in turn stored in the battery within the thermal system. The diesel generator may be set to turn on to support load when there is power disruption in the thermal system, at a power parameter of, for example, 500 W and turn off at a power parameter of, for example, 0 when it is not needed, by its management system. The diesel generator management system may communicate the real time power parameter with timestamps to the thermal system. The power parameter of the diesel generator may be monitored by a dynamometer or other means. The diesel generator's temperature may be affected by the power output of the diesel and the SOC of the battery within the thermal system. The diesel generator's temperature may be higher when it is turned on than it is switched off. The algorithm of the machine learning model for predicting the diesel generator's temperature may comprise a function of the power parameter of the diesel generator.

The multivariate time-series input data used herein has the common meaning as a person skilled in the art would understand and, in particular, may include time-series temperature and one or more time-series variables, for example, ambient temperature of an energy storage system, SoC of an energy storage system, a power parameter of an energy supply system, or the like.

The algorithm of the machine learning model for predicting the temperature of the battery may be selected to comprise a function of the SoC, ambient temperature and the temperature of the battery. A function may be constructed based on the time-series temperature of the battery, the time-series SoC of the battery and the time-series ambient temperature of the battery as follows:

$${T}_{Battery \_ predicted} = ( {T}_{Battery} , SoC , {T}_{ambie} ) \qquad ( 1 )$$

where T_{Battery_predicted} is the prediction of the battery temperature, T_{Battery} is the time-series temperature of the battery, SoC is the time-series SoC of the battery, and T_{ambient} is the time-series ambient temperature of the battery. A combination of the multivariate time-series input data may be selected to forecast or predict the temperature of the battery, as discussed in more detail below, showing improved forecasting or prediction. It also shows that the temperature of the battery is related to its SoC as well as the ambient temperature over time.

The algorithm of the machine learning model for predicting the temperature of the diesel generator may be selected to comprise a function of the time-series temperature of the diesel generator, the time-series SoC of the battery and the time-series power parameter of the diesel generator. A function may be constructed based on the time-series temperature of the diesel generator, the time-series SoC of the battery and the time-series power parameter of the diesel generator as follows:

$${T}_{DG \_ predicted} = ( {T}_{D G} , SoC , {P}_{D G} ) \qquad ( 2 )$$

where T_{DG_predicted} is the prediction of the diesel generator, T_{DG} is the time-series temperature of the diesel generator, SoC is the time-series SoC of the battery, and P_{DG} is the time-series power parameter of the diesel generator. A combination of the multivariate time-series input data may be selected to forecast or predict the temperature of the diesel generator, as discussed in more detail below, showing improved forecasting or prediction. It also shows that the temperature of the diesel generator is related to its power parameter as well as the SoC of the battery in the thermal system over time.

The information of SoC helps to increase the prediction performance of the machine-learning model, as it captures the cycle of charge and discharge of the battery, regardless of the variations of the temperature. For the battery, the variance of the temperature is not significant change, therefore the ambient temperature is also one of the variables that impact the battery temperature. This may have less effect for the diesel generator due to the high variance of its temperature change.

Returning to FIG. 2, for both battery temperature prediction and diesel generator temperature prediction, the training data constitutes 70%, the validation data constitutes 20% and the testing data constitutes 10% of the multivariate time-series input data, as an example. As an example, 118,080 time-series temperature samples (records) are selected for battery temperature prediction and diesel generator temperature prediction, respectively.

Table 1 shows exemplary parameters of a five-layer LSTM architecture that are used for (a) battery temperature prediction and (b) diesel generator temperature prediction.

(a)
Model: “Battery_Temp_Prediction”

| | | Number of |
|---|---|---|
| Layer (type) | Output shape | parameters |
| lstm_1 (LSTM) | (None, 120, 16) | 1280 |
| dropout_1 (Dropout) | (None, 120, 16) | 0 |
| lstm_2 (LSTM) | (None, 120, 16) | 2112 |
| dropout_2 (Dropout) | (None, 120, 16) | 0 |
| lstm_3 (LSTM) | (None, 120, 16) | 2112 |
| dropout_3(Dropout) | (None, 120, 16) | 0 |
| lstm_4 (LSTM) | (None, 120, 16) | 2112 |
| dropout_4 (Dropout) | (None, 120, 16) | 0 |
| lstm_5 (LSTM) | (None, 16) | 2112 |
| dense_1 (Dense) | (None, 30) | 510 |
| reshape_1 (Reshape) | (None, 30, 1) | 0 |

Total parameters: 10,238
Trainable parameters: 10,238
Non-trainable parameters: 10,238
(b)

Model: “Genset_Temp_Prediction”

| | | Number of |
|---|---|---|
| Layer (type) | Output shape | parameters |
| lstm_1 (LSTM) | (None, 120, 48) | 9984 |
| dropout_1 (Dropout) | (None, 120, 48) | 0 |
| lstm_2 (LSTM) | (None, 120, 48) | 18624 |
| dropout_2 (Dropout) | (None, 120, 48) | 0 |
| lstm_3 (LSTM) | (None, 120, 48) | 18624 |
| dropout_3(Dropout) | (None, 120, 48) | 0 |
| lstm_4 (LSTM) | (None, 120, 48) | 18624 |
| dropout_4 (Dropout) | (None, 120, 48) | 0 |
| lstm_5 (LSTM) | (None, 48) | 18624 |
| dense_1 (Dense) | (None, 30) | 1470 |
| reshape_1 (Reshape) | (None, 30, 1) | 0 |

Trainable parameters: 85,950
Non-trainable parameters: 85,950

In Table 1 of the five-layer LSTM architecture for battery temperature prediction, for Layers 1-4, the batch size is indicated as “None”, the time steps are indicated as “120” and the units are indicated as “16”; for Layer 5, also shown as dense layer, the batch size is shown as “None”, the output time steps is indicated as “30”, the units is indicated as “16”. The total number of parameters is 10,238. Herein, “batch size” represents how many data are in each batch, “time steps” indicates how many data points exist in a sequence, and “units” indicates how many dimensions are used to represent a data in one time step. For example, if each value in the sequence is one-hot encoded with n bits, where one of the n bits is set to “1” while the remaining n−1 bits are set to “0”, then “units” is n (e.g., “10” in the case of n bits). The dense layer is also named as “Fully-connected layer” where each neuron is connected to all of the neurons from the next layer.

In Table 1 (b) of the five-layer LSTM architecture for diesel generator temperature prediction, for Layers 1-4, the batch size is indicated as “None”, time steps is indicated as “120” and units is indicated as “48”; for Layer 5, the batch size is indicated as “None”, the output time steps is indicated as “30”, and units is indicated as “48”. The total number of parameters is 85,950.

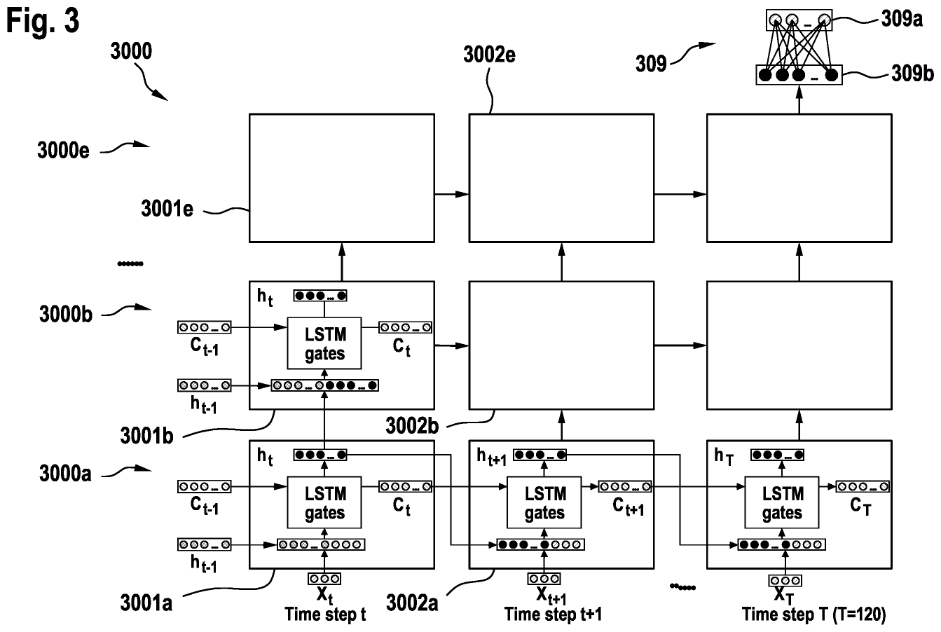

FIG. 3 depicts a block diagram of a LSTM architecture 3000 for predicting temperature of a genset, in accordance with various embodiments of the present disclosure.

The LSTM architecture 3000 may be also used for predicting temperature of a battery with parameters as used herein; for example, the number of units is 16. In the following, the terms “LSTM architecture” and “LSTM model” will be used interchangeably. A sequence of multivariate time-series data can be input to the LSTM architecture 3000 as designed and shown in FIG. 3. The LSTM architecture 3000 may have an input layer 3000a, an output layer 3000e and 3 hidden layers (of which layer 3000b is shown as an example). It would be appreciated by a person skilled in the art that the number of the hidden layers can be one or more layers other than 3. Each of the layers of the LSTM model 3000 may have a number of LSTM cells (e.g., including, 3001a, 3002a, 3001b, 3002b, 3001e, 3002e) corresponding to time steps of the multivariate time-series input data. There are 120 time steps shown in FIG. 3 and the number of units is 48. Three features is input. Processing the pre-processed multivariate time-series input data in the LSTM architecture 3000 (machine learning architecture), in one of the LSTM cells at a time step t of one of the layers of the LSTM model 3000, may comprise the following processes: receiving a previous cell state parameter from an immediate previous LSTM cell at time step t−1 of the same layer; a previous hidden state parameter from the immediate previous LSTM cell at time step t−1 of the same layer; and a hidden state parameter from a previous corresponding LSTM cell at time step t of an immediate previous layer, wherein when the layer is the input layer, receiving an input of the pre-processed multivariate time-series input data at time step t;

generating a cell state parameter for input to an immediate subsequent LSTM cell at time step t+1 of the same layer; and concatenating the previous hidden state parameter with the hidden state parameter for input to a subsequent corresponding LSTM cell at time step t of an immediate subsequent layer, and wherein when the layer is the input layer, concatenating the previous hidden state parameter with the input of the pre-processed multivariate time-series input data for input to the immediate subsequent LSTM cell at time step t+1 of the same layer.

In the input LSTM layer 3000a, LSTM cell 3001a receives a previous cell state parameter Cₜ₋₁ from an immediate previous LSTM cell at time step t−1 of the same layer (not shown); the previous hidden state parameter hₜ₋₁ from the immediate previous LSTM cell at time step t−1 of the same layer (not shown); and an input of the pre-processed multivariate time-series input data Xₜ at time step t. The input data Cₜ₋₁, hₜ₋₁ and Xₜ will be subject to activation function (for example, equation (2) as shown previously) in the LSTM cell 3001a to generate a cell state parameter Cₜ for input to an immediate subsequent LSTM cell 3002a at time step t+1 of the same layer 3000a. The previous hidden state parameter hₜ₋₁ concatenates with the input of the pre-processed multivariate time-series input data Xₜ for input to a subsequent corresponding LSTM cell 3001b at time step t of an immediate subsequent layer 3000b and to the immediate subsequent LSTM cell 3002a at time step t+1 of the same layer 3000a.

In each hidden LSTM layer, for example, 3000b, LSTM cell 3001b receives a previous cell state parameter Cₜ₋₁ from an immediate previous LSTM cell at time step t−1 of the same layer (not shown); the previous hidden state parameter hₜ₋₁ from the immediate previous LSTM cell at time step t−1 of the same layer (not shown); and a hidden state parameter hₜ from a previous corresponding LSTM cell 3001a at time step t of an immediate previous layer 3000a at time step t. The input data Cₜ₋₁, hₜ₋₁ and Xₜ will be subject to activation function (for example, equation (2) as shown previously) in the LSTM cell 3001b to generate a cell state parameter Cₜ for input to an immediate subsequent LSTM cell 3002b at time step t+1 of the same layer 3000b. The previous hidden state parameter hₜ₋₁ concatenates with the hidden state parameter hₜ from a previous corresponding LSTM cell 3001a at time step t of an immediate previous layer 3000a for input to a subsequent corresponding LSTM cell at time step t of an immediate subsequent layer (not shown).

In the output LSTM layer 3000e, LSTM cell 3001e receives a previous cell state parameter Cₜ₋₁ from an immediate previous LSTM cell at time step t−1 of the same layer (not shown); the previous hidden state parameter hₜ₋₁ from the immediate previous LSTM cell at time step t−1 of the same layer (not shown); and a hidden state parameter hₜ from a previous corresponding LSTM cell at time step t of an immediate previous layer at time step t (not shown). The input data Cₜ₋₁, hₜ₋₁ and Xₜ will be subject to activation function (for example, equation (2) as shown previously) in the LSTM cell 3001e to generate a cell state parameter Cₜ for input to an immediate subsequent LSTM cell 102 at time step t+1 of the same layer 3000e. The concatenated from multivariate time-series captures the characteristic of the time-series temperature. A fully connected layer comprising 30 time steps (309a) and 48 units (309b) of LSTM will be output as shown in the inset 309 of the FIG. 3.

It would be appreciated by a person skilled in the art that the LSTM architecture may comprise a chain of repeating modules and the LSTM cell at time step t is a repeat of itself at time step t−1.

Table 2 shows the results for comparison between the LSTM based modelling and RNN based modelling (a) for battery temperature prediction and (b) for diesel generator (DG) temperature prediction. The features shown in column 4 represent multivariates that are used in the algorithm for machine learning.

| | | | | Train Result | |
|---|---|---|---|---|---|
| No. | Model | Time steps | Number of features | validation | test |

(a)

| | | | | | |
|---|---|---|---|---|---|
| 1 | RNN | 2 hours predict | 1: battery temperature | mse: 0.0025 | mse: 0.0031 |
| | | 0.5 hour | | mae: 0.0287 | mae: 0.0298 |
| 2 | LSTM | 2 hours predict | 1: battery temperature | mse: 0.00051 | mse: 0.00048 |
| | | 0.5 hour | | mae: 0.0132 | mae: 0.0137 |
| 3 | RNN | 2 hours predict | 3: battery temperature, | mse: 0.0010 | mse: 0.0012 |
| | | 0.5 hour | batt_soc, T_ambient | mae: 0.0232 | mae: 0.0267 |
| 4 | LSTM | 2 hours predict | 3: battery temperature, | mse: 0.00041 | mse: 0.00038 |
| | | 0.5 hour | batt_soc, T_ambient | mae: 0.0121 | mae: 0.0129 |

(b)

| | | | | | |
|---|---|---|---|---|---|
| 1 | RNN | 2 hours predict | 1: DG_temp | mse: 0.0110 | mse: 0.0089 |
| | | 0.5 hour | | mae: 0.0559 | mae: 0.0502 |
| 2 | LSTM | 2 hours predict | 1: DG_temp | mse: 0.0093 | mse: 0.0076 |
| | | 0.5 hour | | mae: 0.00171 | mae: 0.00165 |
| 3 | RNN | 2 hours predict | 1: DG_temp | mse: 0.0012 | mse: 0.00091 |
| | | 5 minutes | | mae: 0.386 | mae: 0.364 |
| 4 | LSTM | 2 hours predict | 1: DG_temp | mse: 0.00085 | mse: 0.00079 |
| | | 5 minutes | | mae: 0.00132 | mae: 000113 |
| 5 | RNN | 2 hours predict | 3: DG_temp, | mse: 0.0052 | mse: 0.0041 |
| | | 0.5 hour | batt_soc, DG_power | mae: 0.0355 | mae: 0.0308 |
| 6 | LSTM | 2 hours predict | 3: DG_temp, | mse: 0.0031 | mse: 0.0033 |
| | | 0.5 hour | batt_soc, DG_power | mae: 0.0235 | mae: 0.0221 |
| 7 | RNN | 2 hours predict | 3: DG_temp, | mse: 0.00096 | mse: 0.00090 |
| | | 5 minutes | batt_soc, DG_power | mae: 0.0140 | mae: 0.0128 |
| 8 | LSTM | 2 hours predict | 3: DG_temp, | mse: 0.00061 | mse: 0.00056 |
| | | 5 minutes | batt_soc, DG_power | mae: 0.0095 | mae: 0.0082 |

Referring to Table 2 (a) for battery temperature prediction, the multivariate time-series input data is received for an input period of 2 hours and output battery's temperature predictions of a period of 0.5 hours. Row 1 shows the results where only the time-series battery temperature data is used for RNN based modelling. Row 2 shows the results where only the time-series battery temperature data is used for LSTM based modelling. For Rows 1 and 2, only univariate is applied for the algorithm fitting. Row 3 and Row 4 show the results where the time-series battery temperature data, the time-series SoC of the battery and the time-series ambient temperature are used for RNN based modelling and for LSTM based modelling, respectively. For Rows 3 and 4, multivariates are applied for the algorithm fitting. It can be seen that the MSE (Mean Square Error) and MAE (Mean Absolute Error) of validation and test in Row 2 for LSTM based modelling is less than that in Row 1 for RNN based modelling. Similarly, it can be seen that the MSE and MAE of validation and test in Row 4 for LSTM based modelling is less than that in Row 3 for RNN based modelling. Furthermore, it can be seen that the MSE and MAE of validation and test in Row 4 for multivariate LSTM based modelling is less than that in Row 2 for univariate LSTM based modelling.

Referring to Table 2 (b) for diesel generator temperature prediction, the multivariate time-series input data is received for an input period of 2 hours and output diesel generator's temperature predictions of a period of 0.5 hours and 5 minutes. Similar results to the above Table 2 (a) are obtained. Moreover, it can be seen that the MSE and MAE of validation and test in Row 8 for an output period of 5 minutes for multivariate LSTM based modelling is less than that in Row 6 for an output period of 0.5 hours.

It would be appreciated by a person skilled in the art that the input period may vary in connection with practical requirements, e.g., it can be as long as one month, or one year, or as short as one minute, or one second. Analogously, the output period can be as long as one month, or one year, or as short as one minute, or one second. In particular, the multivariate time-series input data may be received for an input period that is an integer multiple of an output period for which the temperature predictions are output. The output period may be predetermined for a number of next time steps.

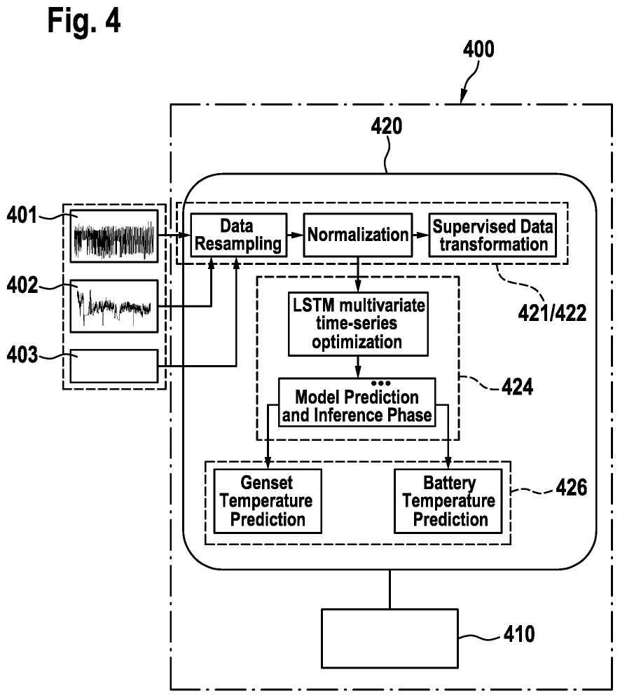

FIG. 4 depicts a schematic block diagram of a system 400 for predicting temperature of a thermal system, according to various embodiments of the present disclosure. The system 400 comprises a memory 410, and at least one processor 420 communicatively coupled to the memory 410 and configured to: receive multivariate time-series input data associated with the thermal system, wherein the multivariate time-series input data includes time-series temperature and one or more time-series variables; pre-process the multivariate time-series input data; process the pre-processed multivariate time-series input data in a machine learning architecture; and output, from the machine learning architecture, temperature predictions for the thermal system based on the multivariate time-series input data.

It will be appreciated by a person skilled in the art that the at least one processor 420 may be configured to perform the required functions or operations through set(s) of instructions (e.g., software modules) executable by the at least one processor 420 to perform the required functions or operations. Accordingly, as shown in FIG. 4, the system 400 may comprise a data receiving module 421, a data preparation module 422, a machine learning module 424 and an output module 426. The time-series multivariate input data may comprise time-series genset temperature data 401, time-series battery temperature data 402, and/or other time-series data 403. The time-series multivariate input data may be preprocessed in the data preparation module 422. The data preparation module 422 may resample the multivariate time-series input data to obtain resampled input data, the data points of which are spaced at equal time intervals; normalize a value of the multivariate time-series input data to a range [0, 1]; and transform time-series format into supervised-learning format.

It will be appreciated by a person skilled in the art that the above-mentioned modules are not necessarily separate modules, and one or more modules may be realized by or implemented as one functional module (e.g., a circuit or a software program) as desired or as appropriate without deviating from the scope of the present disclosure. For example, the machine learning module 424 and the output module 426 may be realized (e.g., compiled together) as one executable software program (e.g., software application or simply referred to as an “app”), which for example may be stored in the memory 410 and executable by the at least one processor 420 to perform the functions/operations as described herein according to various embodiments. Similarly, the data receiving module 421 and the data preparation module 422 may be compiled together.

In various embodiments, the system 400 corresponds to the method 100 as described hereinbefore with reference to FIG. 1, therefore, various functions or operations configured to be performed by the least one processor 420 may correspond to various steps of the method 100 described hereinbefore according to various embodiments, and thus need not be repeated with respect to the system 400 for clarity and conciseness. In other words, various embodiments described herein in context of the methods are analogously valid for the respective systems, and vice versa.

For example, in various embodiments, the memory 410 may have stored therein the algorithm for the machine learning, which respectively corresponds to various steps of the method 100 as described hereinbefore according to various embodiments, which are executable by the at least one processor 420 to perform the corresponding functions/operations as described herein.

In various embodiments, there is provided a computer program product, embodied in one or more computer-readable storage mediums (non-transitory computer-readable storage medium), comprising instructions (e.g., the machine learning module 424) executable by one or more computer processors to perform a method 100 of processing the pre-processed multivariate time-series input data in a machine learning architecture, as described hereinbefore with reference to FIG. 1. Accordingly, various computer programs or modules described herein may be stored in a computer program product receivable by a system therein, such as the system 400 as shown in FIG. 4, for execution by at least one processor 420 of the system 400 to perform the required or desired functions.

While embodiments of the disclosure have been particularly shown and described with reference to specific embodiments, it should be understood by those skilled in the art that various changes in form and detail may be made therein without departing from the scope of the disclosure as defined by the appended claims. The scope of the disclosure is thus indicated by the appended claims and all changes which come within the meaning and range of equivalency of the claims are therefore intended to be embraced.

1. A method (100) for predicting temperature of a thermal system, using at least one processor, the method comprising:
receiving (110) multivariate time-series input data associated with the thermal system, wherein the multivariate time-series input data includes time-series temperature and one or more time-series variables;
pre-processing (120) the multivariate time-series input data;
processing (130) the pre-processed multivariate time-series input data in a machine learning architecture; and
outputting (140), from the machine learning architecture, temperature predictions for the thermal system based on the processed multivariate time-series input data.

2. The method of claim 1, wherein processing (130) the pre-processed multivariate time-series input data in a machine learning architecture comprises determining relationships between the time-series temperature and the one or more time-series variables.

3. The method of claim 2, wherein determining the relationships between the time-series temperature and the one or more time-series variables comprises performing a correlation test between the time-series temperature and the one or more time-series variables.

4. The method of claim 1, wherein the thermal system comprises an energy storage system, and wherein the one or more time-series variables comprise a time-series variable representing a State-of-Charge of the energy storage system.

5. The method of claim 4, wherein the one or more time-series variables further comprise time-series ambient temperature of the energy storage system, and wherein obtaining temperature predictions for the thermal system comprises obtaining temperature predictions for the energy storage system in the thermal system.

6. The method of claim 4, wherein the thermal system further comprises an energy supply system, wherein the one or more time-series variables further comprise time-series power parameter of the energy supply system in the thermal system, and wherein obtaining temperature predictions for the thermal system comprises obtaining temperature predictions for the energy supply system in the thermal system.

7. The method of claim 1, wherein pre-processing (120) the multivariate time-series input data comprises:
resampling the multivariate time-series input data to obtain resampled input data, the data points of which are spaced at equal time intervals;
normalizing a value of the multivariate time-series input data to a range [0, 1]; and
transforming time-series format into supervised-learning format.

8. The method of claim 7, wherein pre-processing (120) the multivariate time-series input data further comprises splitting the multivariate time-series input data into training data (212, 222), validation data (214, 224) and testing data (216, 226), and wherein the processing of the pre-processed multivariate time-series input data in the machine learning architecture further comprises:
a training phase, in which the training data is fed to an algorithm of the machine learning architecture;
a validation phase, in which the validation data is fed to the algorithm of the machine learning architecture; and
a test phase, in which the test data is fed to the algorithm of the machine learning architecture.

9. The method of claim 1, wherein receiving (110) the multivariate time-series input data comprises receiving the multivariate time-series input data is received for an input period that is an integer multiple of an output period for which the temperature predictions are output.

10. The method of claim 1, wherein the machine learning architecture (3000) comprises a Long Short-Term Memory (LSTM) model having an input layer (3000a), an output layer (3000e) and one or more hidden layers (3000b);
wherein each of the layers of the LSTM model has a number of LSTM cells corresponding to time steps of the multivariate time-series input data; and
wherein processing the pre-processed multivariate time-series input data in the machine learning architecture, in one of the LSTM cells at a time step t of one of the layers of the LSTM model, comprises the following processes:
receiving
a previous cell state parameter from an immediate previous LSTM cell at time step t−1 of the same layer;
a previous hidden state parameter from the immediate previous LSTM cell at time step t−1 of the same layer; and
a hidden state parameter from a previous corresponding LSTM cell at time step t of an immediate previous layer, wherein when the layer is the input layer, receiving an input of the pre-processed multivariate time-series input data at time step t;
generating a cell state parameter for input to an immediate subsequent LSTM cell at time step t+1 of the same layer; and
concatenating the previous hidden state parameter with the hidden state parameter for input to a subsequent corresponding LSTM cell at time step t of an immediate subsequent layer, and wherein when the layer is the input layer, concatenating the previous hidden state parameter with the input of the pre-processed multivariate time-series input data for input to the immediate subsequent LSTM cell at time step t+1 of the same layer.

11. A system (400) for predicting temperature of a thermal system, the system (400) comprising:
a memory (410); and
at least one processor communicatively coupled to the memory (410) and configured to:
receive multivariate time-series input data associated with the thermal system by a data receiving module (421), wherein the multivariate time-series input data includes time-series temperature and one or more time-series variables;
pre-process the multivariate time-series input data by a data preparation module (422);
process the pre-processed multivariate time-series input data in a machine learning architecture by a machine learning module (424); and
output by an output module (426), from the machine learning architecture, temperature predictions for the thermal system based on the multivariate time-series input data.

12. A non-transitory computer-readable storage medium containing instructions that when executed by a computer cause the computer to
receive multivariate time-series input data associated with the thermal system,
wherein the multivariate time-series input data includes time-series temperature and one or more time-series variables;
pre-process the multivariate time-series input data;
process the pre-processed multivariate time-series input data in a machine learning architecture; and
output, from the machine learning architecture, temperature predictions for the thermal system based on the processed multivariate time-series input data.
